(19) United States
(12) Patent Application Publication
(10) Pub. No.: US 2018/0322465 A1
(43) Pub. Date: Nov. 8, 2018

(54) EMBEDDABLE WEB-AUTHENTICATED INSTANT JOB INTEGRATION SYSTEM AND METHOD

(71) Applicant: A Resume Company Inc., San Francisco, CA (US)

(72) Inventor: Sia Safikhani, Concord, CA (US)

(21) Appl. No.: 15/588,197

(22) Filed: May 5, 2017

(51) Int. Cl. G06Q 10/10; G06F 17/30

(52) U.S. Cl. CPC G06Q 10/1053; G06F 17/30864

(57) ABSTRACT

Embodiments can provide a non-transitory computer program product for web-authenticated instant job integration (WAIJI), the computer program product comprising a non-transitory computer readable storage medium having program instructions embodied therewith, the program instructions executable by a processor to cause the processor to receive, from a client website, an authentication request; transmit, to a WAIJI database, an authentication verification request; receive, from the WAIJI database, an authentication verification; and transmit, to the client website, one or more object scripts and templates allowing the client website to provide job searching functionality to one or more users.

### TECHNOLOGY FIELD

The present disclosure generally relates to a system and method for fully integrating job search and posting functionality on a single web-based platform including, all objects, styling, interaction, and data aggregation.

### BACKGROUND

Job searching and job posting can be a cumbersome process, especially for businesses who want to leverage their already pre-built web platforms in order to include job search functionality. Several large services have arisen that allow employee seekers to post job descriptions and solicit resumes from job seekers, but those platforms require a user to specifically use the service provider's web page and discourage any embedding within third-party websites. Currently, there is no present solution for a business to quickly and easily integrate job posting functionality within its own website and allow users to search for jobs without needing to leave the business web page.

### SUMMARY

Embodiments can provide a non-transitory computer program product for web-authenticated instant job integration (WAIJI), the computer program product comprising a non-transitory computer readable storage medium having program instructions embodied therewith, the program instructions executable by a processor to cause the processor to receive, from a client website, an authentication request; transmit, to a WAIJI database, an authentication verification request; receive, from the WAIJI database, an authentication verification; and transmit, to the client website, one or more object scripts and templates allowing the client website to provide job searching functionality to one or more users.

Embodiments can further provide a non-transitory computer program product wherein the processor is further caused to receive, from the client website, position/keyword and location information; communicate the position/keyword and location information to the one or more job board APIs; receive, from the one or more job board APIs, one or more job postings; and transmit, to the client website, the one or more job postings for display.

Embodiments can further provide a non-transitory computer program product wherein the processor is further caused to transmit, to the client website, additional object scripts and templates allowing the client website to display location, date of posting, and description information associated with each of the one or more job postings.

Embodiments can further provide a non-transitory computer program product wherein the processor is further caused to transmit, to the client website, one or more job board logos associated with each job board API that provides a member of the one or more job postings.

Embodiments can further provide a non-transitory computer program product wherein the processor is further caused to receive, from the client website, one or more job alert requests, along with contact, position/keyword, and location information entered by the user; and transmit, to one or more job alert vendors, the contact, position/keyword and location information entered by the user.

Embodiments can further provide a non-transitory computer program product wherein the processor is further caused to receive one or more existing resumes uploaded by one or more users.

Embodiments can further provide a non-transitory computer program product wherein the processor is further caused to receive one or more custom-built resumes created by one or more users.

Embodiments can further provide a system for web-authenticated instant job integration (WAIJI), comprising a WAIJI API server configured to receive, from a client website, an authentication request; transmit, to a WAIJI database, an authentication verification request; receive, from the WAIJI database, an authentication verification; and transmit, to the client website, one or more object scripts and templates allowing the client website to provide job searching functionality to one or more users.

Embodiments can further provide a system wherein the WAIJI API server is further configured to receive, from the client website, position/keyword and location information; communicate the position/keyword and location information to the one or more job board APIs; receive, from the one or more job board APIs, one or more job postings; and transmit, to the client website, the one or more job postings for display.

Embodiments can further provide a system wherein the WAIJI API server is further configured to transmit, to the client website, additional object scripts and templates allowing the client website to display location, date of posting, and description information associated with each of the one or more job postings.

Embodiments can further provide a system wherein the WAIJI API server is further configured to transmit, to the client website, one or more job board logos associated with each job board API that provides a member of the one or more job postings.

Embodiments can further provide a system wherein the WAIJI API server is further configured to receive, from the client website, one or more job alert requests, along with contact, position/keyword, and location information entered by the user; and transmit, to one or more job alert vendors, the contact, position/keyword, and location information entered by the user.

Embodiments can further provide a system wherein the WAIJI API server is further configured to receive one or more existing resumes uploaded by one or more users.

Embodiments can further provide a system wherein the WAIJI API server is further configured to receive one or more custom-built resumes created by one or more users.

Embodiments can further provide a computer implemented method, in a data processing system comprising a processor and a memory comprising instructions which are executed by the processor to cause the processor to implement a web-authenticated instant job integration system, the method comprising receiving, from a client website, an authentication request; transmitting, to a WAIJI database, an authentication verification request; receiving, from the WAIJI database, an authentication verification; and transmitting, to the client website, one or more object scripts and templates allowing the client website to provide job searching functionality to one or more users.

Embodiments can further provide a method further comprising receiving, from the client website, position/keyword and location information; communicating the position/keyword and location information to the one or more job board APIs; receiving, from the one or more job board APIs, one or more job postings; and transmitting, to the client website, the one or more job postings for display.

Embodiments can further provide a method further comprising transmitting, to the client website, additional object scripts and templates allowing the client website to display location, date of posting, and description information associated with each of the one or more job postings.

Embodiments can further provide a method further comprising transmitting, to the client website, one or more job board logos associated with each job board API that provides a member of the one or more job postings.

Embodiments can further provide a method further comprising receiving, from the client website, one or more job alert requests, along with contact, position/keyword, and location information entered by the user; and transmitting, to one or more job alert vendors, the contact, position/keyword, and location information entered by the user.

Embodiments can further provide a method further comprising receiving one or more existing resumes uploaded by one or more users.

Embodiments can further provide a method further comprising receiving one or more custom-built resumes created by one or more users.

Additional features and advantages of this disclosure will be made apparent from the following detailed description of illustrative embodiments that proceeds with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the inventions described herein, there is shown in the drawings embodiments that are presently preferred, it being understood, however, that the inventions are not limited to the specific instrumentalities disclosed. Included in the drawings are the following Figures:

FIG. 1 illustrates a block diagram depicting the components of a web-authenticated instant job integration system, according to embodiments described herein;

FIG. 2 illustrates a flowchart diagram depicting authentication functionality of a web-authenticated instant job integration system, according to embodiment described herein;

FIG. 3 illustrates a screenshot of an example user interface of a web-authenticated instant job integration system, according to embodiments described herein;

FIG. 4 illustrates a block diagram depicting the components of a web-authenticated instant job integration system, according to embodiments described herein;

FIG. 5 illustrates a flowchart diagram depicting job searching functionality of a web-authenticated instant job integration system, according to embodiment described herein;

FIG. 6 illustrates a screenshot of an example user interface of a web-authenticated instant job integration system, according to embodiments described herein;

FIG. 7 illustrates a block diagram depicting the components of a web-authenticated instant job integration system, according to embodiments described herein;

FIG. 8 illustrates a block diagram depicting the components of resume uploading and creation for a web-authenticated instant job integration system; and

FIG. 9 illustrates an example of a computing environment within which embodiments of the invention may be implemented.

### DETAILED DESCRIPTION OF EXEMPLARY EMBODIMENTS

The following disclosure describes the present invention according to several embodiments directed at a system for instantly and seamlessly integrating job posting and searching functionality within a web-based platform. The web-authenticated instant job integration system can provide a simple code snippet, which can be authenticated, that can be pasted into any website, allowing for instant and seamless job search, job results, and job alerts including all objects, styling, interactions, and data aggregation operated on the aforementioned website. This can be accomplished through providing full access to search for jobs by accessing an API (access point interface), which in turn can pull jobs from target job providers and can provide a seamless and interactive experience within the client website. The web-authenticated instant job integration system can be supported across all major web browsers and mobile devices. The entire setup process can be completed within minutes, saving companies time, money, and providing a fully functional experience from the ground up. Updates and enhancements can be provided automatically and can require no additional work on the part of the client. Customizations such as styling, color themes, and font-types can be supported, providing a more integrated look and feel.

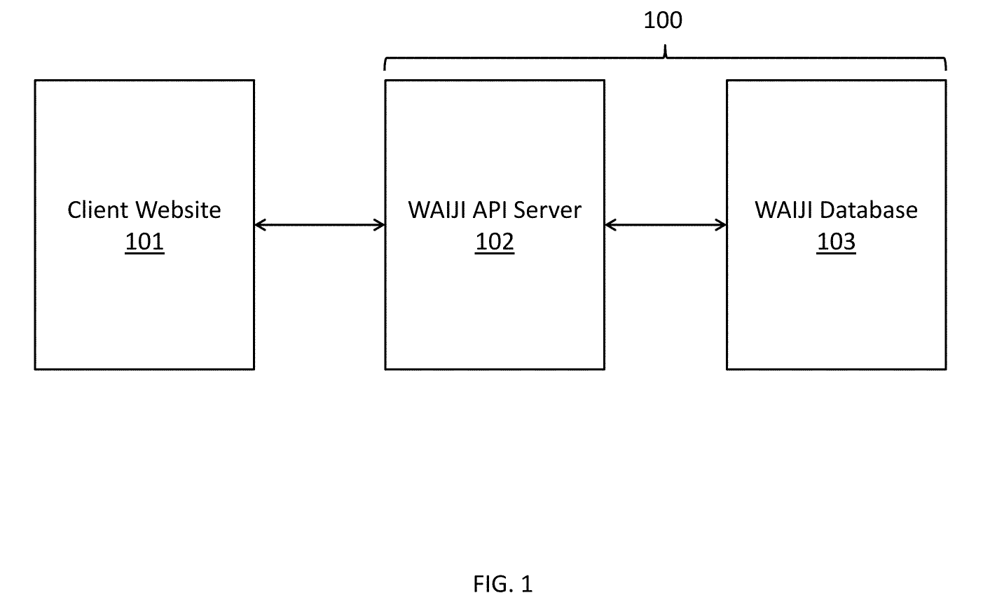

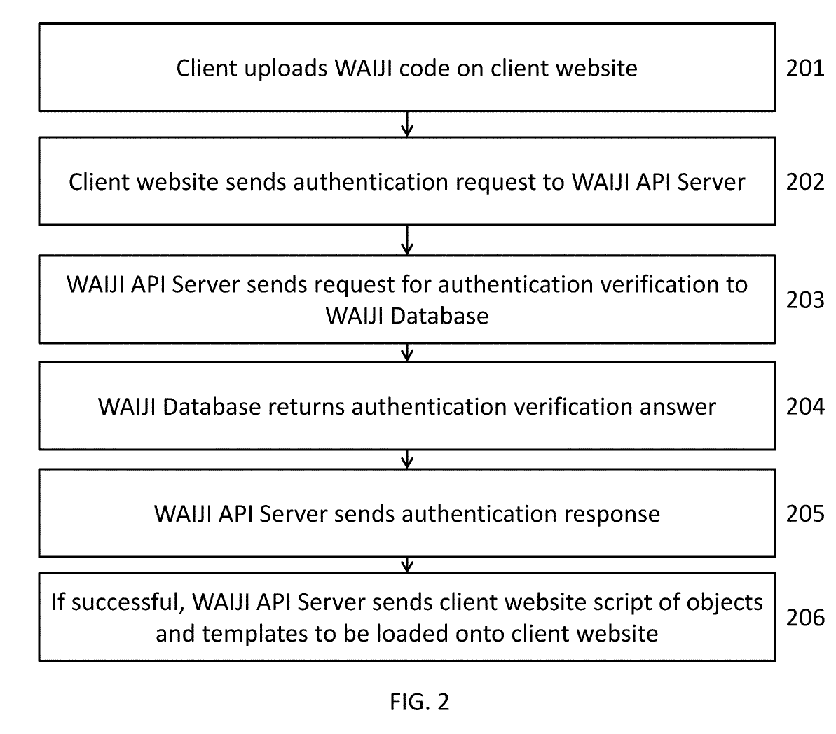

FIGS. 1 and 2 illustrate the authentication functionality of a web-authenticated instant job integration (WAIJI) system, according to embodiment described herein. In an embodiment, the main components of the web-authenticated instant job integration system 100 can be a WAIJI API server 102 and a WAIJI database 103. The WAIJI API server 102 can be the main point of contact for one or more client websites 101, which can utilize the WAIJI system 100. The WAIJI database 103 can be a repository of one or more job postings, as well as a repository for, among other items, search location information based on the IP address of machine used to search, location information entered by user, search queries of jobs, jobs that come back relative to search, what the user searched for and where the user searched from, search patterns, webpage content, flags for account, account information (i.e., user names and passwords), images, and uploaded resumes.

In order to integrate the WAIJI system on the client website 101, the client can first upload one or more lines of WAIJI code onto the client website 201, as shown in FIG. 2. These one or more lines of code can allow the client website 101 to send an authentication request to the WAIJI API server 202. The WAIJI API server 102, upon receiving the authentication request from the client website 101, in turn can submit a request for authentication verification 203 to the WAIJI database 103. The WAIJI database 103, upon receiving an authentication verification request from the WAIJI API server 102, can evaluate the request and return an authentication verification answer 204. If the authentication is successful, the WAIJI database 103 can return an authentication verification indicator of true. If the authentication fails, then the WAIJI database 103 can return an authentication verification indicator of false. If the authentication verification indicator received by the WAIJI API server 102 is false, the WAIJI API server can take no further action, returning nothing and making no impact on the client website 101. Alternately, based on a true authentication verification indicator, the WAIJI API server 102 can send the client website 101 an authentication response 205. If the response is successful, the WAIJI API server 102 can send the client website 101 scripts of objects and the templates to be loaded on the client website 206, which can allow the client website 101 the capability to provide job searching functionality to its users.

In an embodiment, the object scripts and templates to be sent from the WAIJI API server 102 to the client website can include one or more of a CSS framework and a JavaScript framework. The CSS framework can be used to handle styling, while the JavaScript framework can be used to handle user interactions. Additional functionalities can be added, including user customizations and/or updates, as well as potential integrations with a mapping service or alerting service. The frameworks can include event handlers and locational services that can determine the location of the user using the system. Alternate programming languages other than CSS and JavaScript can be used to implement the styling, user interaction, and other functionalities.

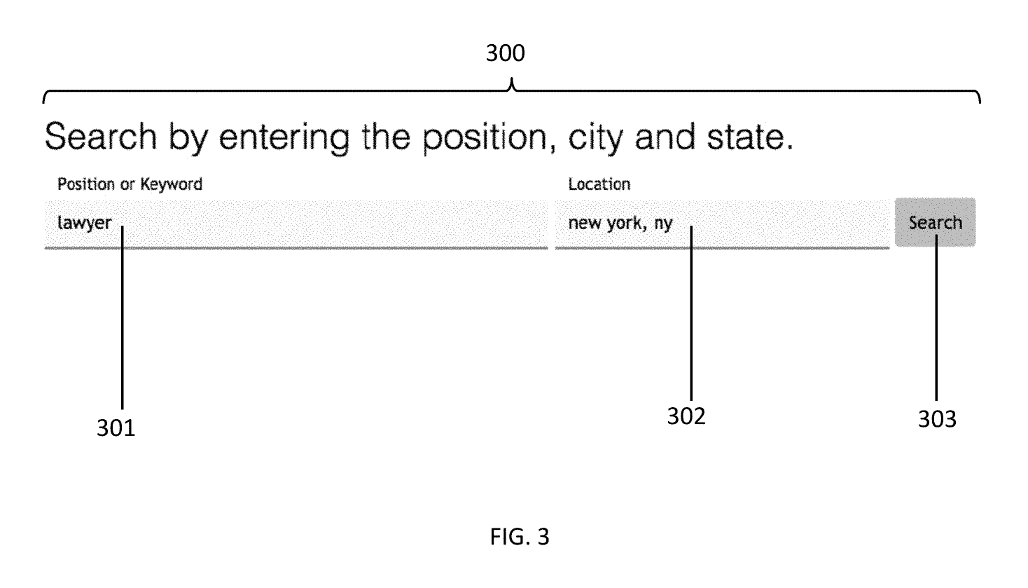

FIG. 3 illustrates a screenshot of an example user interface of a web-authenticated instant job integration system, according to embodiments described herein. In an embodiment, FIG. 3 shows an example of what a user would see after the client website has successfully integrated with the WAIJI API server and the WAIJI database. The entry user interface 300 can have a position/keyword field 301 for the user to enter either a direct position title, or keywords relating to desired positions that the WAIJI system can search for. Additionally, a location field 302 can be filled by the user to include a proximate area to focus the search. In an embodiment, location services on the device used by the user to access the client website can be used to populate the location field 302. In an embodiment, the entry user interface 300 can be programmed such that both the location field 302 and the position/keyword field 301 must be populated before a search can occur. In alternate embodiments, one or the other field may be left blank, while still allowing search functionality. Once the position/keyword field 301 and/or the location field 302 are populated by the user, the user can initiate the search using the search button 303.

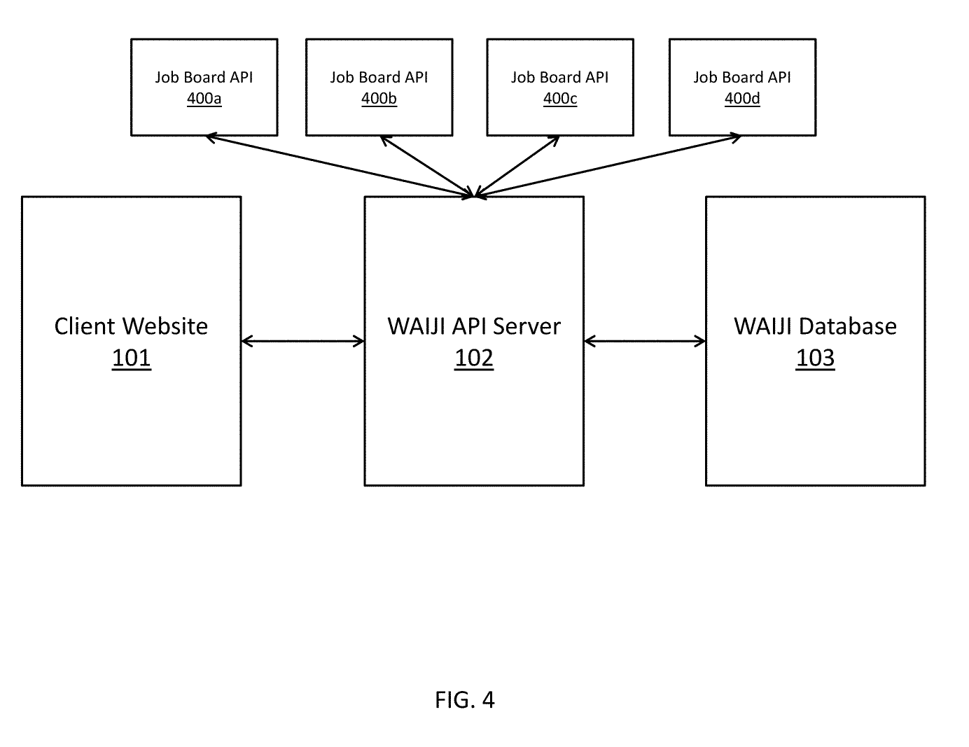

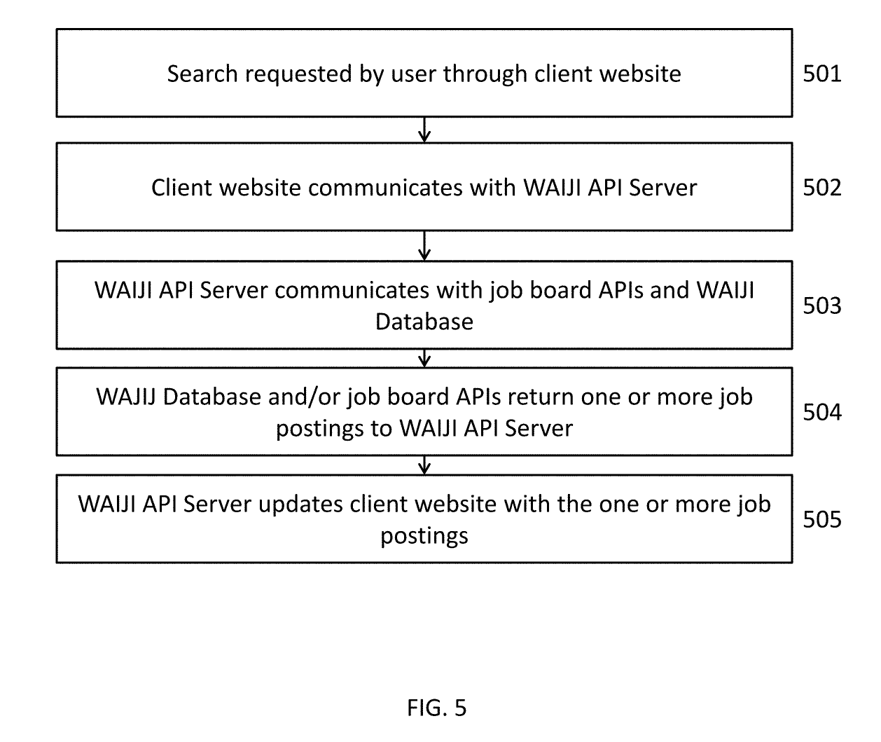

FIGS. 4 and 5 illustrate job searching functionality of a web-authenticated instant job integration system, according to embodiment described herein. First, as described above, a user can request a search through the client website 501, which can include position/keyword information as well as location information. The client website 101 can then communicate with the WAIJI API server 102, which can include sending the WAIJI API server the position/keyword and location information entered by the user 502. The WAIJI API server 102 can then communicate with the WAIJI database 103 and one or more job board APIs 503. The job board APIs 400 can be independently created and programmed by third-party job vendors, such as Jobs2Careers 400a, Monster 400b, Indeed 400c, ZipRecruiter 400d, etc., and can interface with their respective stores of job postings. Each job board API 400 can request and provide data in different formats, and may require different security protocols such that unique lines of communication for each job board API 400 with the WAIJI API server 102 may be required. The WAIJI system can read each of the differently formatted data and communicate using the different security protocols, but can translate each of the unique characteristics such that all information displayed on the client website 101 is uniform, despite its aggregation from differently formatted websites. Additionally, the WAIJI database 103 can also contain a store of job postings that have been directly posed to the WAIJI system. In an embodiment, a user can create a job posting that is stored on the WAIJI system through the client website 101. The user can fill out necessary job posting information on the client website 101, including job title, location, and job description. Upon submission, all job posting information can be stored in the WAIJI database 103. When a job-seeking user searches for a job, the posting information can be searched to see if a potential match occurs with the WAIJI database. The job-seeking user searching jobs can then see the new job posted along with all other posted jobs that fit the designated search criteria.

Upon communication with the WAIJI API server 102, the WAIJI database 103 and/or one or more of the job board APIs 400 can return one or more job postings to the WAIJI API server 504. In response to having one or more job postings returned, the WAIJI API server 102 can update the user interface of the client website 101 with the one or more job postings 505.

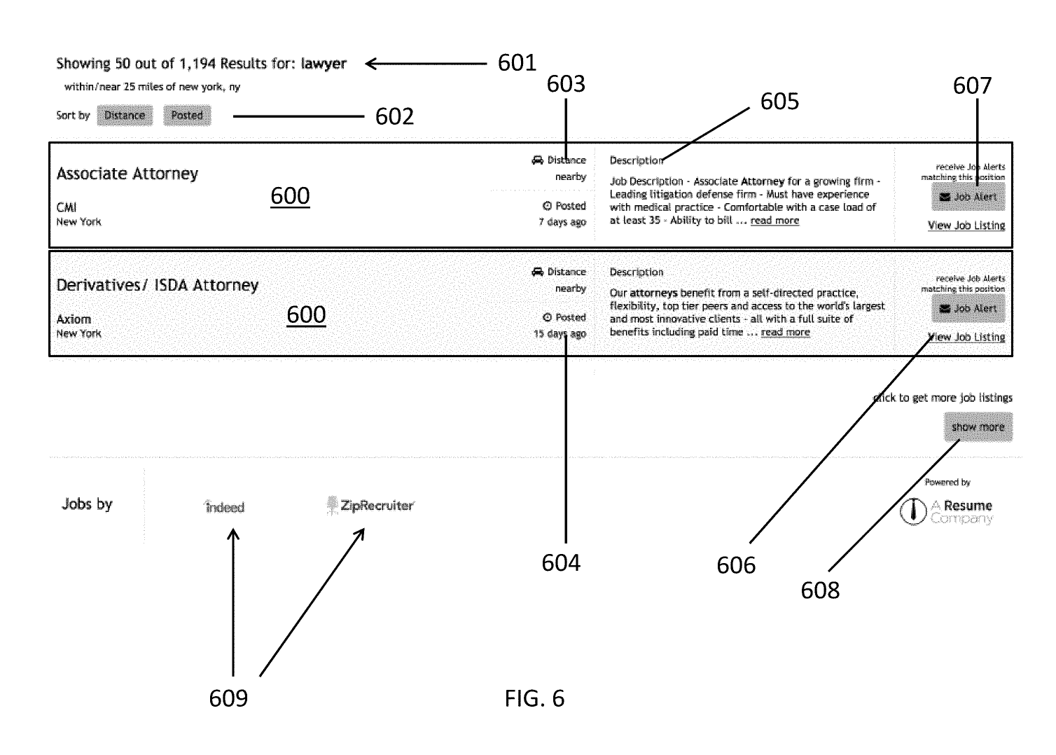

FIG. 6 illustrates a screenshot of an example user interface of a web-authenticated instant job integration system, according to embodiments described herein. After the WAIJI API server returns one or more job postings 600 to the client website, the client website can alter the user interface to display the one or more job postings 600 in a manner easily accessible to the user. The user interface can include a display count 601 of job postings, which can include how many postings are displayed and the total number of postings found based on the position/keyword and location information originally entered by the user. The user can have the option to sort the list of one or more job postings 600 based upon the postings' distance or how recently the job was posted 602. The user can have the option of altering the search radius of acceptable jobs, such that the WAIJI system can display jobs within a particular radius of a location (e.g., within 5, 10, 15, etc., miles of a particular location). Each job posting 600 can have displayed the distance to the location entered by the user 603, as well as information pertaining to how recent the job was posted to the job board 604. In an embodiment, the distance can be displayed as “nearby”, when the job is within a mile of the location designated by the user. The job posting 600 can include a description of the job 605, which can be provided by the job poster. The user can be presented with a link to the original job posting 606, which can take the user to the third-party job vendor site where the full job posting resides. Additionally, the user may create an alert for jobs matching the job posting using the job alert button 607, as described further herein. If the user wishes to see most job postings, the user can use a “show more” button 608 to display additional job postings. The user interface can display the logos of the third-party vendors 609 from which the one or more job postings 600 are gathered from.

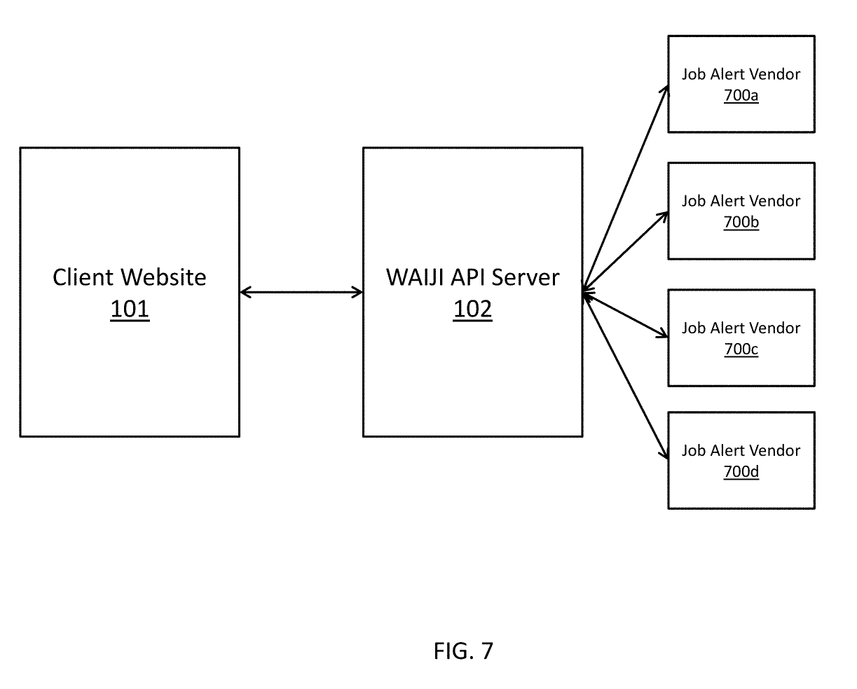

FIG. 7 illustrates a block diagram depicting the components of a web-authenticated instant job integration system, according to embodiments described herein. If a user initiates a job alert request after viewing one or more job postings through the user interface, the WAIJI system can prompt the user to enter his/her email address information, and confirm with the user the position/keyword information, as well as the location information, which can constrain what jobs are searched. The client website 101 can then communicate with the WAIJI API server 102 and send the position/keyword, location, and contact information. The WAIJI API server 102 can in turn communicate with one or more job alert vendors 700a, 700b, 700c, 700d, which can facilitate setup of alerts through the various job board APIs used to formerly populate the user interface with the one or more job postings. In an embodiment, job alerts can be configured by the user to be received daily, weekly, monthly, or on an as-is basis as a job fulfilling the criteria of the user's job alert information is posted to one of the job board vendors' sites. When a job-seeker signs up for an alert, the data can be integrated into the WAIJI database. The job alert vendors will send any matched job posting from the alert to the job seeker. In an embodiment, the job posting can appear “white-labeled”, as if coming directly from the WAIJI system.

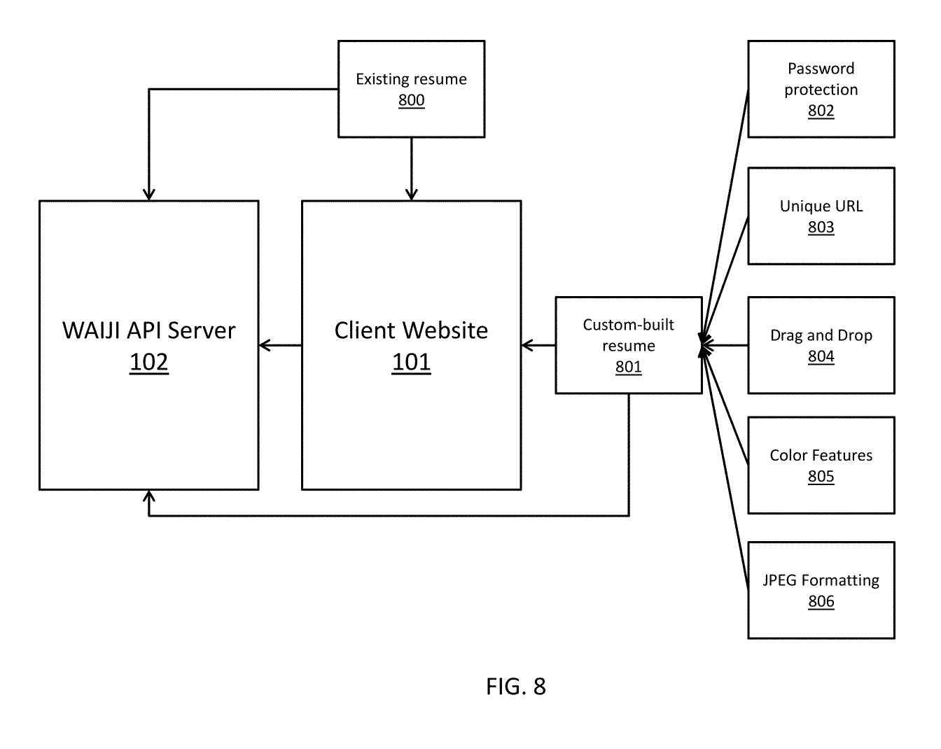

FIG. 8 illustrates a block diagram illustrating resume posting functionality of a web authenticated instant job integration system, in accordance with embodiments described herein. In an embodiment, a user can create an account. Upon creating an account, the job-seeker can either upload an existing resume 800 or can create their own custom-built resume 801. Any type of file (jpeg, pdf, word doc, etc.) can be uploaded as a resume. To create a custom-made resume 801, the user can utilize the following functions: password protection 802, which can protect the user account and the specific resume; a unique URL 803 with corresponding hashtag, which can be used to quickly direct the user back to the resume in progress; drag and drop of elements 804, which can be used to drop different template blocks (education, work experience, etc.); color features 805, which can be used to change the color of text or any graphics on the resume; jpeg formatting 806, which can be effected through customized coding that can allows the jpeg-ized resume to display in a variety of formats; as well as general formatting options (font, paragraph, etc.). The user then can submit the resume to the WAIJI API Server 102 through any client website 101. The resume can be stored in the WAIJI database. When applying for a job found through WAIJI, the user can submit a particular resume through the use of a drop-down menu that can display all resumes uploaded or created by the user. In an embodiment, the user can download any uploaded existing resume 800 or custom-built resume 801 to local storage. In an alternate embodiment, the WAIJI system can prevent the user from downloading a custom-built resume 801 to local storage.

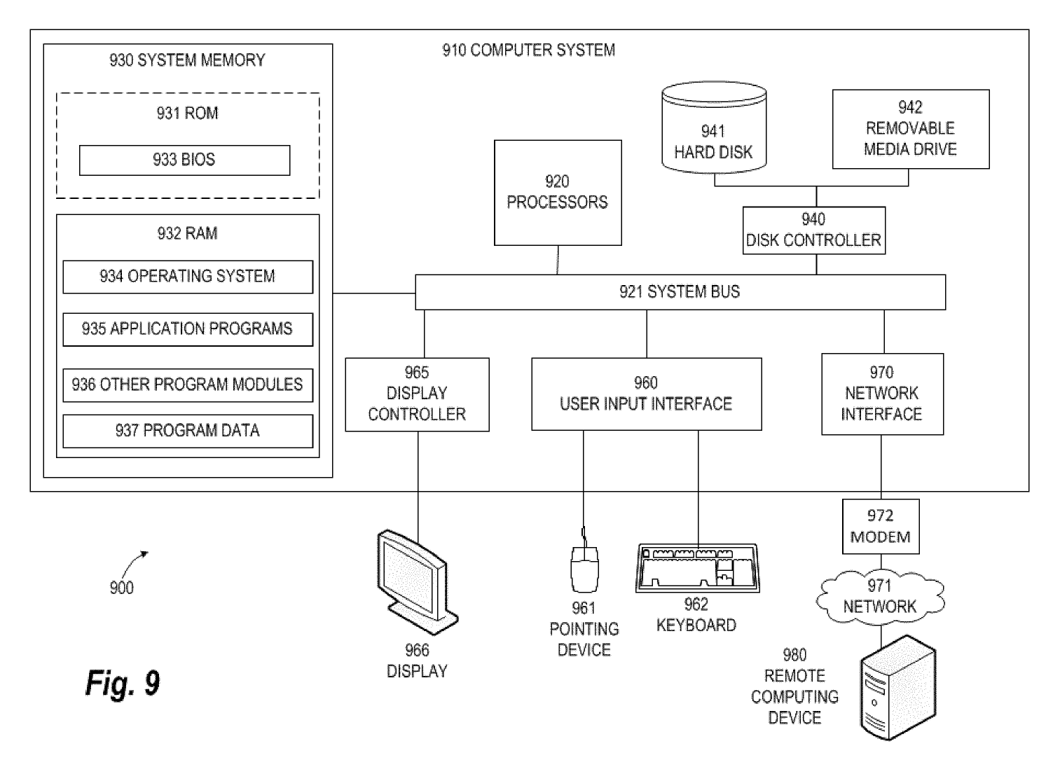

FIG. 9 illustrates an example of a computing environment 900 within which embodiments of the invention may be implemented. Computing environment 900 may be implemented as part of any component described herein. Computing environment 900 may include computer system 910, which is one example of a computing system upon which embodiments of the invention may be implemented. As shown in FIG. 9, the computer system 910 may include a communication mechanism such as a bus 921 or other communication mechanism for communicating information within the computer system 910. The system 910 further includes one or more processors 920 coupled with the bus 921 for processing the information. The processors 920 may include one or more CPUs, GPUs, or any other processor known in the art.

The computer system 910 also includes a system memory 930 coupled to the bus 921 for storing information and instructions to be executed by processors 920. The system memory 930 may include computer readable storage media in the form of volatile and/or nonvolatile memory, such as read only memory (ROM) 931 and/or random access memory (RAM) 932. The system memory RAM 932 may include other dynamic storage device(s) (e.g., dynamic RAM, static RAM, and synchronous DRAM). The system memory ROM 931 may include other static storage device(s) (e.g., programmable ROM, erasable PROM, and electrically erasable PROM). In addition, the system memory 930 may be used for storing temporary variables or other intermediate information during the execution of instructions by the processors 920. A basic input/output system (BIOS) 933 containing the basic routines that help to transfer information between elements within computer system 910, such as during start-up, may be stored in ROM 931. RAM 932 may contain data and/or program modules that are immediately accessible to and/or presently being operated on by the processors 920. System memory 930 may additionally include, for example, operating system 934, application programs 935, other program modules 936 and program data 937.

The computer system 910 also includes a disk controller 940 coupled to the bus 921 to control one or more storage devices for storing information and instructions, such as a magnetic hard disk 941 and a removable media drive 942 (e.g., floppy disk drive, compact disc drive, tape drive, and/or solid state drive). The storage devices may be added to the computer system 910 using an appropriate device interface (e.g., a small computer system interface (SCSI), integrated device electronics (IDE), Universal Serial Bus (USB), or FireWire).

The computer system 910 may also include a display controller 965 coupled to the bus 921 to control a display or monitor 966, such as a cathode ray tube (CRT) or liquid crystal display (LCD), for displaying information to a computer user. The computer system 910 includes a user input interface 960 and one or more input devices, such as a keyboard 962 and a pointing device 961, for interacting with a computer user and providing information to the processor 920. The pointing device 961, for example, may be a mouse, a trackball, or a pointing stick for communicating direction information and command selections to the processor 920 and for controlling cursor movement on the display 966. The display 966 may provide a touch screen interface which allows input to supplement or replace the communication of direction information and command selections by the pointing device 961.

The computer system 910 may perform a portion or all of the processing steps of embodiments of the invention in response to the processors 920 executing one or more sequences of one or more instructions contained in a memory, such as the system memory 930. Such instructions may be read into the system memory 930 from another computer readable medium, such as a hard disk 941 or a removable media drive 942. The hard disk 941 may contain one or more data stores and data files used by embodiments of the present invention. Data store contents and data files may be encrypted to improve security. The processors 920 may also be employed in a multi-processing arrangement to execute the one or more sequences of instructions contained in system memory 930. In alternative embodiments, hard-wired circuitry may be used in place of or in combination with software instructions. Thus, embodiments are not limited to any specific combination of hardware circuitry and software.

As stated above, the computer system 910 may include at least one computer readable medium or memory for holding instructions programmed according to embodiments of the invention and for containing data structures, tables, records, or other data described herein. The term “computer readable medium” as used herein refers to any non-transitory, tangible medium that participates in providing instructions to the processor 920 for execution. A computer readable medium may take many forms including, but not limited to, non-volatile media, volatile media, and transmission media. Non-limiting examples of non-volatile media include optical disks, solid state drives, magnetic disks, and magneto-optical disks, such as hard disk 941 or removable media drive 942. Non-limiting examples of volatile media include dynamic memory, such as system memory 930. Non-limiting examples of transmission media include coaxial cables, copper wire, and fiber optics, including the wires that make up the bus 921. Transmission media may also take the form of acoustic or light waves, such as those generated during radio wave and infrared data communications.

The computing environment 900 may further include the computer system 910 operating in a networked environment using logical connections to one or more remote computers, such as remote computer 980. Remote computer 980 may be a personal computer (laptop or desktop), a mobile device, a server, a router, a network PC, a peer device or other common network node, and typically includes many or all of the elements described above relative to computer 910. When used in a networking environment, computer 910 may include modem 972 for establishing communications over a network 971, such as the Internet. Modem 972 may be connected to system bus 921 via network interface 970, or via another appropriate mechanism.

Network 971 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 910 and other computers (e.g., remote computing system 980). The network 971 may be wired, wireless, or a combination thereof. Wired connections may be implemented using Ethernet, Universal Serial Bus (USB), RJ-11, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 971.

A processor as used herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting, or transmitting information for use by an executable procedure or an information device, and/or by routing the information to an output device. A processor may use or comprise the capabilities of a computer, controller or microprocessor, for example, and is conditioned using executable instructions to perform special purpose functions not performed by a general purpose computer. A processor may be coupled (electrically and/or as comprising executable components) with any other processor enabling interaction and/or communication there-between. Computer program instructions may be loaded onto a computer, including, without limitation, a general purpose computer or special purpose computer, or other programmable processing apparatus to produce a machine, such that the computer program instructions which execute on the computer or other programmable processing apparatus create means for implementing the functions specified in the block(s) of the flowchart(s). A user interface processor or generator is a known element comprising electronic circuitry or software or a combination of both for generating display elements or portions thereof. A user interface (UI) comprises one or more display elements enabling user interaction with a processor or other device.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters. A graphical user interface (GUI), as used herein, comprises one or more display elements, generated by a display processor and enabling user interaction with a processor or other device and associated data acquisition and processing functions.

The UI also includes an executable procedure or executable application. The executable procedure or executable application conditions the display processor to generate signals representing the UI display images. These signals are supplied to a display device which displays the elements for viewing by the user. The executable procedure or executable application further receives signals from user input devices, such as a keyboard, mouse, light pen, touch screen or any other means allowing a user to provide data to a processor. The processor, under control of an executable procedure or executable application, manipulates the UI display elements in response to signals received from the input devices. In this way, the user interacts with the display elements using the input devices, enabling user interaction with the processor or other device. The functions and process steps herein may be performed automatically or wholly or partially in response to user command. An activity (including a step) performed automatically is performed in response to executable instruction or device operation without user direct initiation of the activity.

A workflow processor, as used herein, processes data to determine tasks to add to, or remove from, a task list or modifies tasks incorporated on, or for incorporation on, a task list, as for example specified in a program(s). A task list is a list of tasks for performance by a worker, user of a device, or device or a combination of both. A workflow processor may or may not employ a workflow engine. A workflow engine, as used herein, is a processor executing in response to predetermined process definitions that implement processes responsive to events and event associated data. The workflow engine implements processes in sequence and/or concurrently, responsive to event associated data to determine tasks for performance by a device and or worker and for updating task lists of a device and a worker to include determined tasks. A process definition is definable by a user and comprises a sequence of process steps including one or more, of start, wait, decision and task allocation steps for performance by a device and or worker, for example. An event is an occurrence affecting operation of a process implemented using a process definition. The workflow engine includes a process definition function that allows users to define a process that is to be followed and may include an Event Monitor.

The system and processes of the figures presented herein are not exclusive. Other systems, processes, and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. Further, the processes and applications may, in alternative embodiments, be located on one or more (e.g., distributed) processing devices on a network linking the units of FIG. 9. Any of the functions and steps provided in the Figures may be implemented in hardware, software or a combination of both. No claim element herein is to be construed under the provisions of 35 U.S.C. 18, sixth paragraph, unless the element is expressly recited using the phrase “means for.”

What is claimed is:

1. A non-transitory computer program product for web-authenticated instant job integration (WAIJI), the computer program product comprising a non-transitory computer readable storage medium having program instructions embodied therewith, the program instructions executable by a processor to cause the processor to:
receive, from a client website, an authentication request;
transmit, to a WAIJI database, an authentication verification request;
receive, from the WAIJI database, an authentication verification; and
transmit, to the client website, one or more object scripts and templates allowing the client website to provide job searching functionality to one or more users.

2. The non-transitory computer program product as recited in claim 1, wherein the processor is further caused to:
receive, from the client website, position/keyword and location information;
communicate the position/keyword and location information to the one or more job board APIs;
receive, from the one or more job board APIs, one or more job postings; and
transmit, to the client website, the one or more job postings for display.

3. The non-transitory computer program product as recited in claim 2, wherein the processor is further caused to:
transmit, to the client website, additional object scripts and templates allowing the client website to display location, date of posting, and description information associated with each of the one or more job postings.

4. The non-transitory computer program product as recited in claim 2, wherein the processor is further caused to:
transmit, to the client website, one or more job board logos associated with each job board API that provides a member of the one or more job postings.

5. The non-transitory computer program product as recited in claim 2, wherein the processor is further caused to:
receive, from the client website, one or more job alert requests, along with contact, position/keyword, and location information entered by the user; and
transmit, to one or more job alert vendors, the contact, position/keyword and location information entered by the user.

6. The non-transitory computer program product as recited in claim 1, wherein the processor is further caused to:
receive one or more existing resumes uploaded by one or more users.

7. The non-transitory computer program product as recited in claim 1, wherein the processor is further caused to:
receive one or more custom-built resumes created by one or more users.

8. A system for web-authenticated instant job integration (WAIJI), comprising:
a WAIJI API server configured to:
receive, from a client website, an authentication request;
transmit, to a WAIJI database, an authentication verification request;
receive, from the WAIJI database, an authentication verification; and
transmit, to the client website, one or more object scripts and templates allowing the client website to provide job searching functionality to one or more users.

9. The system as recited in claim 8, wherein the WAIJI API server is further configured to:
receive, from the client website, position/keyword and location information;
communicate the position/keyword and location information to the one or more job board APIs;
receive, from the one or more job board APIs, one or more job postings; and
transmit, to the client website, the one or more job postings for display.

10. The system as recited in claim 9, wherein the WAIJI API server is further configured to:
transmit, to the client website, additional object scripts and templates allowing the client website to display location, date of posting, and description information associated with each of the one or more job postings.

11. The system as recited in claim 9, wherein the WAIJI API server is further configured to:
transmit, to the client website, one or more job board logos associated with each job board API that provides a member of the one or more job postings.

12. The system as recited in claim 9, wherein the WAIJI API server is further configured to:
receive, from the client website, one or more job alert requests, along with contact, position/keyword, and location information entered by the user; and
transmit, to one or more job alert vendors, the contact, position/keyword, and location information entered by the user.

13. The system as recited in claim 9, wherein the WAIJI API server is further configured to:
receive one or more existing resumes uploaded by one or more users.

14. The system as recited in claim 9, wherein the WAIJI API server is further configured to:
receive one or more custom-built resumes created by one or more users.

15. A computer implemented method, in a data processing system comprising a processor and a memory comprising instructions which are executed by the processor to cause the processor to implement a web-authenticated instant job integration system, the method comprising:
receiving, from a client website, an authentication request;
transmitting, to a WAIJI database, an authentication verification request;
receiving, from the WAIJI database, an authentication verification; and
transmitting, to the client website, one or more object scripts and templates allowing the client website to provide job searching functionality to one or more users.

16. The method as recited in claim 15, further comprising:
receiving, from the client website, position/keyword and location information;
communicating the position/keyword and location information to the one or more job board APIs;
receiving, from the one or more job board APIs, one or more job postings; and
transmitting, to the client website, the one or more job postings for display.

17. The method as recited in claim 16, further comprising:
transmitting, to the client website, additional object scripts and templates allowing the client website to display location, date of posting, and description information associated with each of the one or more job postings.

18. The method as recited in claim 16, further comprising:
transmitting, to the client website, one or more job board logos associated with each job board API that provides a member of the one or more job postings.

19. The method as recited in claim 16, further comprising:
receiving, from the client website, one or more job alert requests, along with contact, position/keyword, and location information entered by the user; and
transmitting, to one or more job alert vendors, the contact, position/keyword, and location information entered by the user.

20. The method as recited in claim 15, further comprising:
receiving one or more existing resumes uploaded by one or more users.

21. The method as recited in claim 15, further comprising:
receiving one or more custom-built resumes created by one or more users.
